(19) United States
(12) Patent Application Publication
(10) Pub. No.: US 2017/0220241 A1
(43) Pub. Date: Aug. 3, 2017

(54) FORCE TOUCH ZOOM SELECTION

(71) Applicant: Onshape Inc., Cambridge, MA (US)

(72) Inventors: Rammohan Vangapalli, Winter Springs, FL (US); Daniel Vlasic, Lexington, MA (US)

(21) Appl. No.: 15/418,021

(22) Filed: Jan. 27, 2017

Related U.S. Application Data
(60) Provisional application No. 62/288,732, filed on Jan. 29, 2016.

(51) Int. Cl. G06F 3/0488; G06F 3/0482; G06F 3/0484; G06F 3/041

(52) U.S. Cl. CPC G06F 3/04883; G06F 3/041; G06F 3/0482; G06F 3/04845; G06F 2203/04105; G06F 2203/04806

(57) ABSTRACT

This solution addresses problems using force touch features on mobile, tablet, or other touch-screen devices by zooming based on the force applied to an area for selection. Zoom may be proportional to force amount, and may be restricted to one direction zoom (zoom-in only). The entire display may be zoomed to maximize effective selection. A selection is made by positioning the finger (or a related selection tool) on the desired target. The selection is retained the instant the user releases the force (lifts finger), at which time the zoom is reverted to the original (non-zoom) level. The one-direction only zoom and instant return avoids re-introducing selection confusion (such as auto-snapping to an undesired target) that may occur with a gradual zoom out.

### CROSS-REFERENCE TO RELATED APPLICATIONS

This utility patent application claims priority from U.S. provisional patent application Ser. No. 62/288,732, filed Jan. 29, 2016, titled “FORCE TOUCH ZOOM SELECTION” naming inventors Rammohan Vangapalli and Daniel Vlasic.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2017, Onshape Inc.

### BACKGROUND

Field of Technology

This relates to a mobile and tablet user interfaces, and more specifically to using force touch to control zooming during graphical selection processes.

Background

Force touch especially 3D touch has been used by Apple shipped applications or other applications in many ways, for example, www.phonearena.com/news/Apps-with-3D-Touch-on-iPhone-6s-here-is-a-list_id74061.

Professional mobile CAD applications and other drawing program may allow editing very complex models. Users often need to pick entities such as points, lines etc. during the editing process. In crowded areas, fine selection of a specific point is quite difficult. A current solution involves the user zooming in a particular region, and then picking the entity or exact location desired. The user then zooms out to get back to the previous context. If the design tool being used or the editing goal requires similar fine selection in multiple areas, this process means users may need to repeatedly zoom in and out several times. This issue issue may exist in any interface display, but has become more pronounced on smaller displays such as tablets and quite prominent on mobile phones.

A similar situation arises during sketching process frequently used in CAD applications. Sketching, or similar applications, may allow a user to “snap” to existing entities or common points (such as to endpoints or the midpoint of a line) while sketching. In some scenarios, such snapping can prevent selection of the desired target by the user. To adjust, the user would zoom in the crowded part of the model to avoid snapping. As a result of the zoom, the rest of model may be off screen. When multiple selections are needed, this can result where the need to zoom to select a source or first selection causes loss of view of the target for a second selection.

Description of Prior Art

U.S. Pat. No. 9,030,419 (issued 2015 May 12, inventor Ian W. Freed, title

“Touch and force user interface navigation”) discloses, in the Abstract, “Techniques for navigating through a user interface with a force-sensitive touch sensor are described. In some implementations, the force-sensitive touch sensor is also a display that presents the user interface. Touches on the force-sensitive touch sensor may be interpreted as indicating a vector direction based on the location of the touch and a vector magnitude based on the force of the touch. For instance, when a user navigates through a collection of photographs on a device having a force-sensitive touch sensor, the vector direction may determine if the user is scrolling forwards or backwards through the photographs and the vector magnitude may determine how rapidly the scrolling occurs. The user may also navigate through a hierarchy of folders and files using touch and force. Selection of a folder and application of force exceeding a threshold may result in display of the contents of a most commonly accessed subfolder or file.”

United States Patent Application Publication 2012/0105367 (published 2012 May 3, inventor Jae S. Son et al., title “Methods of Using Tactile Force Sensing for Intuitive User Interface”) discloses, in the Abstract, “Described are novel methods of user interface for electronic devices using proportional force information. The new user interface is more intuitive, easier to use and requires less finger manipulations. The input device itself is configured for detecting at least one location of touch and measuring a force of touch at this location as in a capacitance sensing tactile pressure array. At least two events defining an output event of the input device are provided for a particular location. Selection of one event or the other is done based on a force of touch being either above or below a predetermined force of touch threshold. More than one force of touch threshold may be provided for one or more locations, along with a corresponding number of events—to further increase the functionality of the input device. The invention may be used in particular with laptop, tablet computers and smartphones.”

U.S. Pat. No. 8,610,684 (issued 2013 Dec. 17, inventor Kalu Onuka Kalu et al., title “System and Method for Controlling an Electronic Device Having a Touch-Sensitive Non-Display Area”) discloses, in the Abstract, “A method and system are provided for controlling a first electronic device connectable to a second electronic device. The first electronic device comprises a touch-sensitive non-display area for detecting one or more touch-sensitive non-display area gestures. Each touch-sensitive non-display area gesture is associated with a respective function of the first electronic device. The method comprises partitioning a touch-sensitive input mechanism of the second electronic device into a non-display portion and a display portion; receiving a gesture using the non-display portion, the gesture corresponding to a touch-sensitive non-display area gesture; and determining an instruction to be performed by the first electronic device based on the gesture.”

None of the above provides a solution with (1) a force touch zoom-in, (2) target selection with the same touch controlling the zoom, (3) zoom-out restricted during target selection, and (4) ending of zoom after selection. What is needed, therefore, is a solution that overcomes the above-mentioned limitations and that includes the features enumerated above.

### BRIEF SUMMARY

This solution addresses problems using force touch features on mobile, tablet, or other touch-screen devices by zooming based on the force applied to an area for selection. Zoom may be proportional to force amount, and may be restricted to one direction zoom (zoom-in only). The entire display may be zoomed to maximize effective selection. A selection is made by positioning the finger (or a related selection tool) on the desired target. The selection is retained the instant the user releases the force (lifts finger), at which time the zoom is reverted to the original (non-zoom) level. The one-direction only zoom and instant return avoids re-introducing selection confusion (such as auto-snapping to an undesired target) that may occur with a gradual zoom out.

### Features and Advantages

This solution allows for a precise and controlled zoom with touchscreen devices, which in turn allows for a better and more precise selection of desired targets or locations.

This solution reduces the number of user interface interactions needed to make selections in situations where zooming is beneficial.

This solution accurately preserves selections made and actions input while zoomed in, without requiring additional user interface interactions to confirm or lock-in a selection.

### BRIEF DESCRIPTION OF THE DRAWINGS

In the drawings, closely related figures and items have the same number but different alphabetic suffixes. Processes, states, statuses, and databases are named for their respective functions.

FIG. 1 is a example user interface display where precise selection of a desired target is difficult within a normal or current display.

FIG. 2 is the example display of FIG. 1, zoomed in through force touch control, illustrating finer selection of a specific target.

FIG. 3 is the example display of FIG. 1, returned to a zoomed out view after releasing a force touch but preserving the selection made as shown in FIG. 2.

FIG. 4 is an example user interface display where precise selection of two endpoints for a line is desired, but prevented in a normal view due to snapping effects around the midpoint of a line.

FIG. 5 is the example display of FIG. 4, illustrating snapping effects at an endpoint of the line.

FIG. 6 is the example display of FIG. 4, zoomed in through force touch control for making a first selection without conflict of snapping effects.

FIG. 7 is the example display of FIG. 4, after selection is made as in FIG. 6 and zoom has returned to the original level.

FIG. 8 is the example display of FIG. 7 illustrating the snapping effects around a midpoint of a line preventing a desired second selection.

FIG. 9 is the example display of FIG. 7 illustrating the snapping effects around aa endpoint of a line preventing a desired second selection.

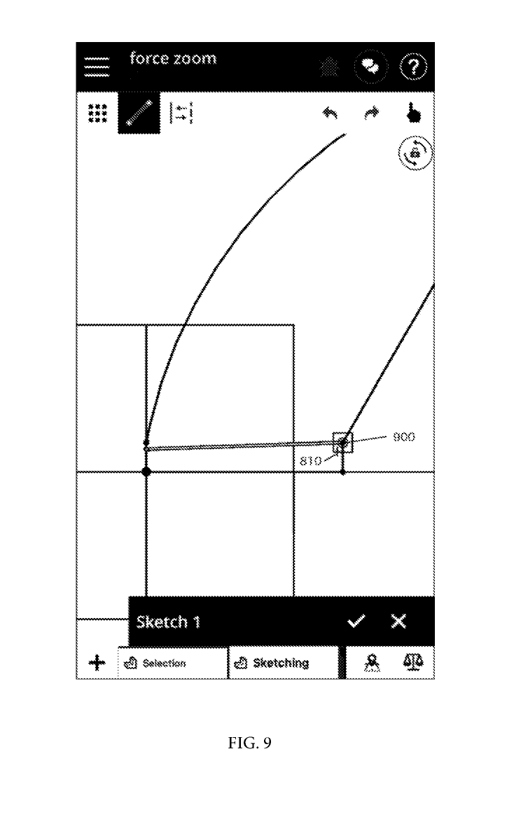

FIG. 10 is the example display of FIG. 7, zoomed in through force touch control for making a second selection without conflict of snapping effects.

FIG. 11 is the example display of FIGS. 4 and 7, after a first selection is made as shown in FIG. 6, and a second selection is made as shown in FIG. 10.

### DETAILED DESCRIPTION, INCLUDING THE PREFERRED EMBODIMENT

In the following detailed description, reference is made to the accompanying drawings which form a part hereof, and in which are shown, by way of illustration, specific embodiments in which the invention may be practiced. It is to be understood that other embodiments may be used, and structural changes may be made without departing from the scope of the present disclosure.

Terminology

The terminology and definitions of the prior art are not necessarily consistent with the terminology and definitions of the current invention. Where there is a conflict, the following definitions apply.

Touchscreen display: A touchscreen display is a display screen for a computer device that can detect contact, determine location, and measure pressure of a finger, stylus, or other tool making physical contact with the screen.

Touch Event: a touch event on a touchscreen display is the contact of a finger or stylus on the display until contact is removed. The touch event includes pressure, which may change during the touch event as the finger or stylus presses harder or lighter on the screen, and a touch point identifying where on the display contact is occurring. The touch point may move during the touch event, and may be tracked as an initial point identifying location contact where the touch event began and a current point identifying location of current contact during the touch event.

Operation

A force touch zoom selection solution may be implemented in software applications, such as computer aided design (CAD) programs, sketching programs, or drawing programs, for mobile, tablet, or other touchscreen computing devices that can detect, measure, or estimate applied force during a touch input command. Examples of current devices with such capabilities include iPhones (models 6S, 6S+, and later) with 3D Touch and iPads (iPad Pro or later models) with stylus touch. The Android API has similarly included functionality to return pressure from a touch event, but most Android devices have yet to include screens designed to accurately measure such pressure. Android devices which include accurate pressure measurement, as well as other force-based touch-screen devices, may similarly be used to run software including the force touch zoom selection solution.

This addresses both these problems using the force touch features on iOS devices to control zoom actions around a selection. iOS SDK gives force as a property of touch for the 3D touch on iPhone 6S and 6S+. Similarly iPad Pro gives the same property through the stylus touch. Other force-based touchscreen devices may similarly be used with implementations on other platforms.

Using Apple's iOS as an example, when pressure changes during a touch an event handler touchesEstimatedPropertiesUpdated is triggered and provides a UITouch object which includes a force property (with 1.0 set to equal force of an average touch). Similarly, the Android platform includes a getPressure function for TouchEvent objects, which may be used to return the pressure applied. The software application implementing force touch zoom selection may use these touch event properties and functions to monitor the force being applied. Similarly, the touch APIs of various platforms may include functions to identify if touch force is enabled or detectable on the individual device, as well as identify a maximum force or pressure measurement.

The force touch zoom selection may be programmed into existing software applications, delivered as a separate application for enabling selection zooming on a device, or implemented in code within the operating system or underlying software platform. The software code implementing force touch zoom selection may be stored on, or accessed for execution by, the computing device processor having a touchscreen display.

Upon detecting an increase in force, the display may be zoomed. One implementation may treat the original pre-touch display as being at a fixed zoom level (for example, 100%), set a maximum zoom amount (for example 4× zoom, or 400%) as being reached reached if the maximum force is detected, and proportionally zoom between the original fixed zoom and the maximum zoom based on any measured force between average and maximum force. The maximum zoom amount may also be implemented as a configurable option (such as through a system or application setting), and different zoom scales may also be configurable options (such as using exponentially increasing zoom with pressure instead of proportional).

When increasing zoom of the display, the preferred implementation uses the touch contact or selection point as a non-moving anchor around which to zoom. The selection point is the point within displayed content currently selected by the touch event. The selection point may be the same as the touch point (directly under the finger or stylus), offset so as to be visible (not blocked by the finger or stylus touching the screen), or a selection auto-snapped to due to proximity to a selectable displayed element. So if the selection point is in the center of the display, the very center content remains in a fixed position while zooming, but if in a corner that corner content remains fixed while zooming. If the touch/selection point moves during a zoom, such as after an initial pressure increase, the touch/selection point moves and then another increase in pressure is detected, the fixed point for the zoom preferably moves with the touch/selection point. This is preferred to ease precise selection, with the user selecting an area of interest for the zoom. Additionally, it is preferable to zoom the entire display window of the application, as that maximizes the visible area for fine selection.

While zooming, a detected increase in pressure my be used to zoom in, while a detected decrease in pressure preferably has no effect. This allows users to zoom in via force touch, relax the pressure to move the finger/stylus as needed for a more precise selection within the zoomed display, and then increase pressure again if further zooming is needed. The application may track pressure level during a touch event such that only increased pressure over prior pressures causes further zooming. For example, a touch may start at average pressure, increase to a first zoom pressure (triggering a corresponding zoom), relax back to near average pressure for movement/selection, then increase again. On that second increase, further zoom will occur only if the detected pressure exceeds the first zoom pressure. This is preferred as the operation can clearly identify when the user wants further zoom. Alternatively, every increase in pressure may increase the zoom, including increased pressure after relaxing after a first pressure zoom where the second pressure increase is still less than the first pressure. This alternate behavior may work best with stepped zooms, where every increase in pressure increases the zoom amount by a fixed step amount. With both the preferred and alternative embodiment, a minimum pressure change may also be utilized to prevent minor pressure changes, such as may occur with normal finger movement, from triggering zooms. This minimum change amount avoids user confusion through unintended zooming.

When pressure decreases, no adjustment is made to the zoom level. This allows the user the opportunity to make a selection within the zoomed in display, and prevents selection confusion from occurring. Should zoom out be implemented in response to reduced pressure, during that zoom out the selection of touch might change as different objects in the display enter the touch region, or auto-snapping occurs. Instead, the zoomed in level is retained (or further zoomed in with further pressure increases), until the touch event is ended (lifting of the finger or stylus).

Upon ending the touch event, the current selection in zoomed display is retained as the actual selection, and the display returns to the original fixed zoom level. This return may be animated to show a visual effect, or automatically made, as by ending the touch event and fixing the selection the issue of selection confusion during zoom-out is avoided.

The figures illustrate various scenarios utilizing the force touch zoom selection solution.

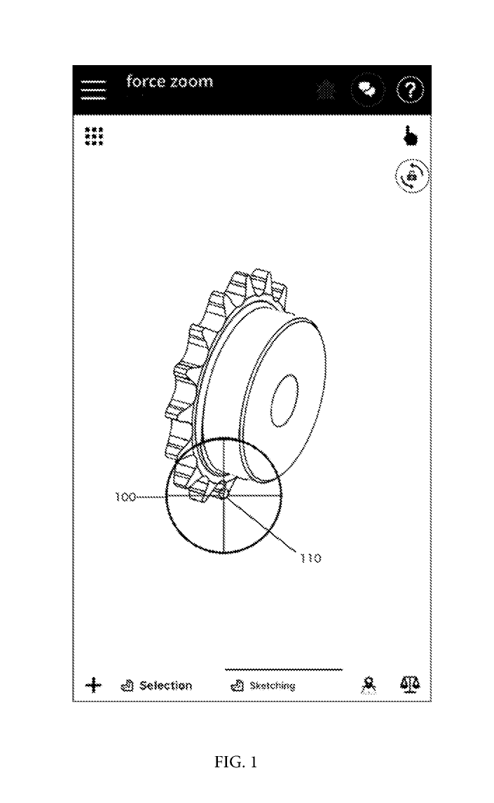

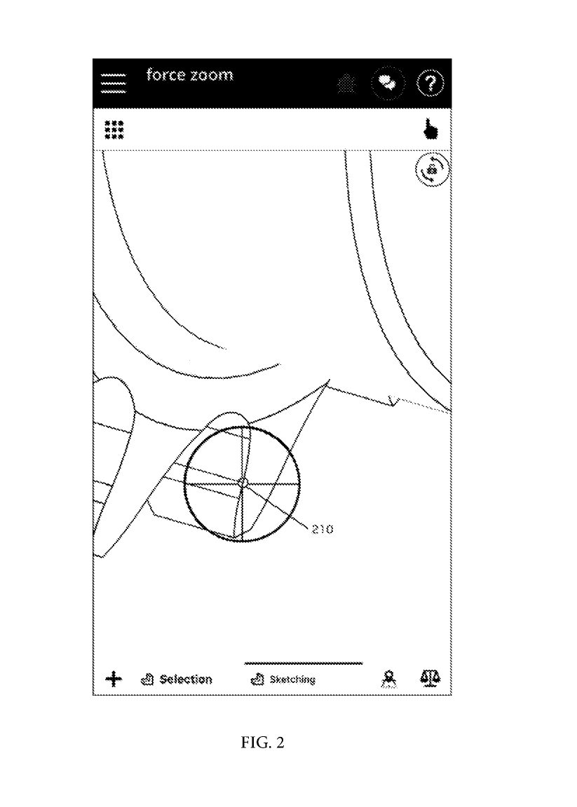

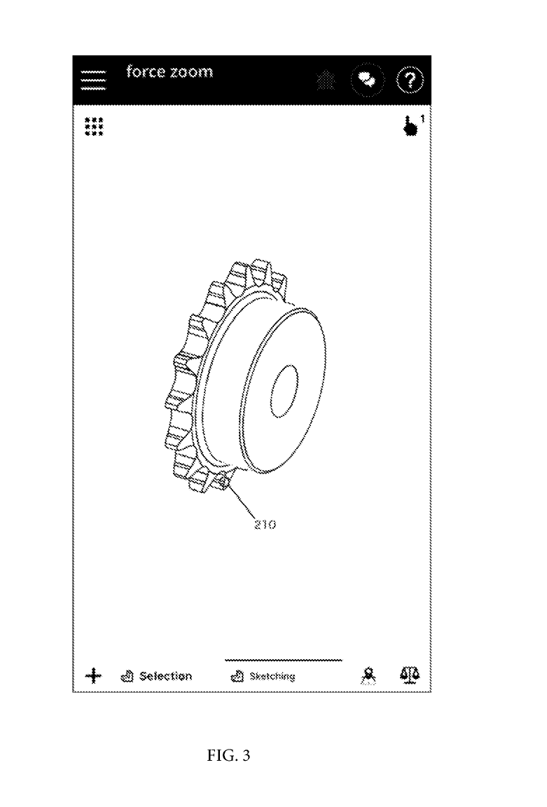

Referring to FIG. 1, a CAD program is operating on a mobile phone implementing force touch zoom selection. The user intent is to select a particular point, but due to the display size on the phone such specific selection is very difficult. In the figure, the touch event is represented by the cross-hairs 100, and at normal zoom the touched point 110 overlaps multiple edges and faces. Referring also to FIG. 2, by applying force during the touch, the application zooms in with the touch point in a fixed location. Selection of the desired point 210 is now possible due to the increase in zoom of the display. Referring also to FIG. 3, after releasing touch (and ending the touch event), the display reverts to the original zoom level but retains the specific selection 210 made while zoomed in.

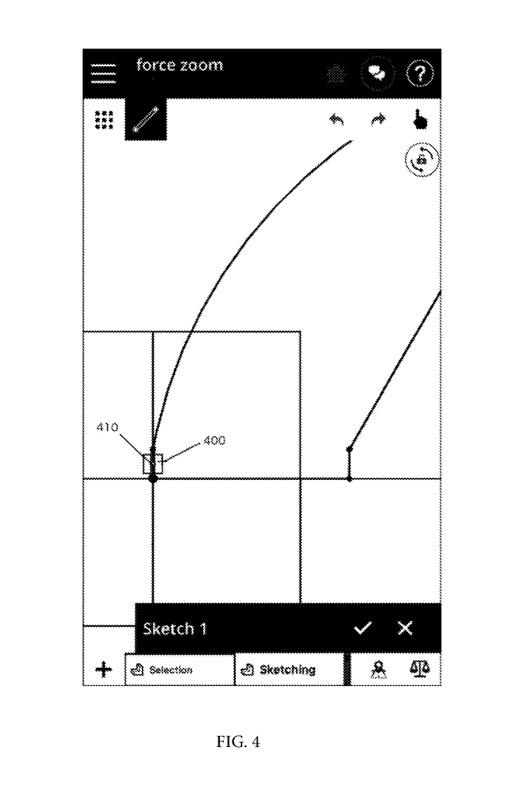

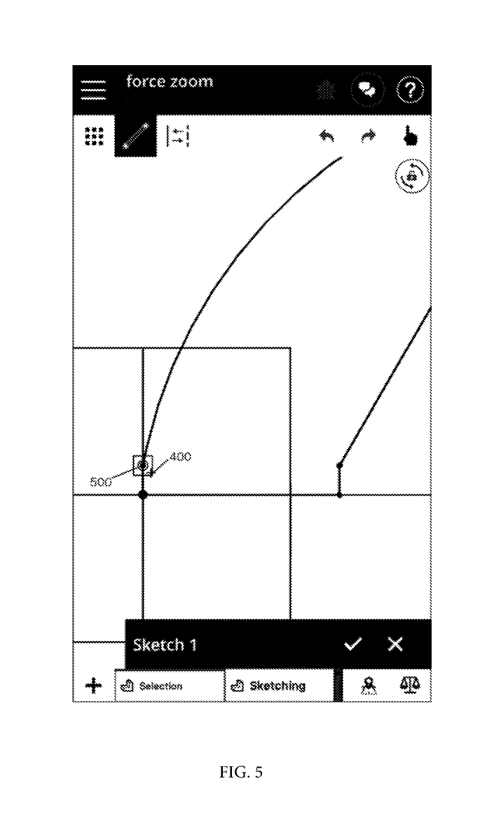

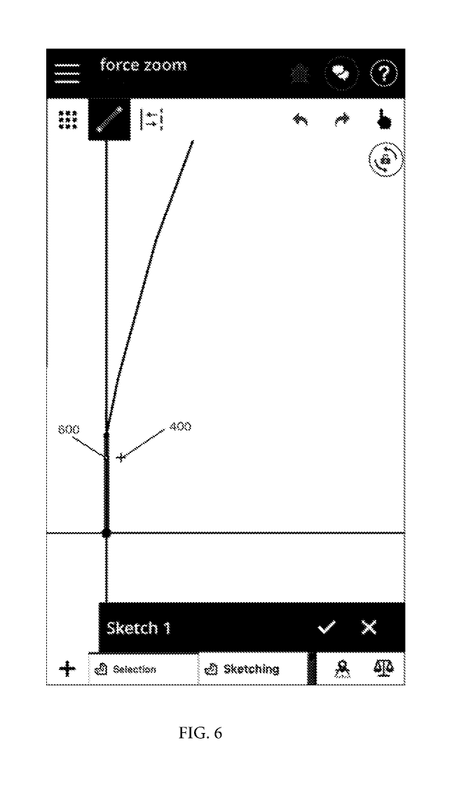

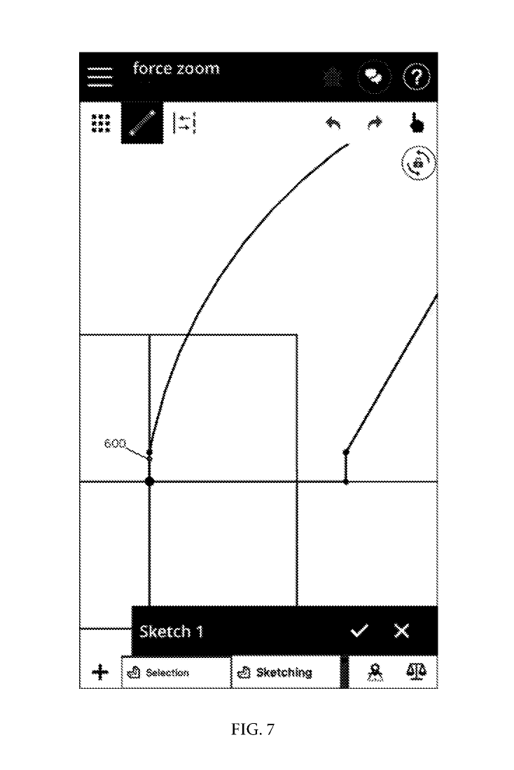

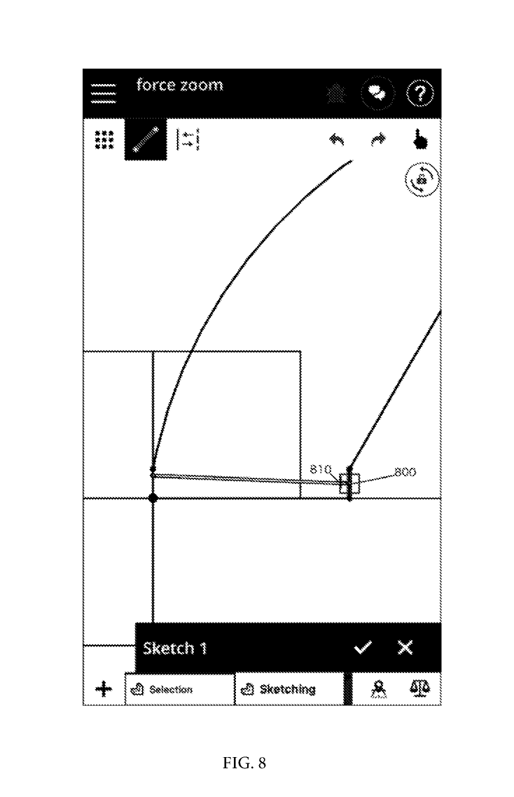

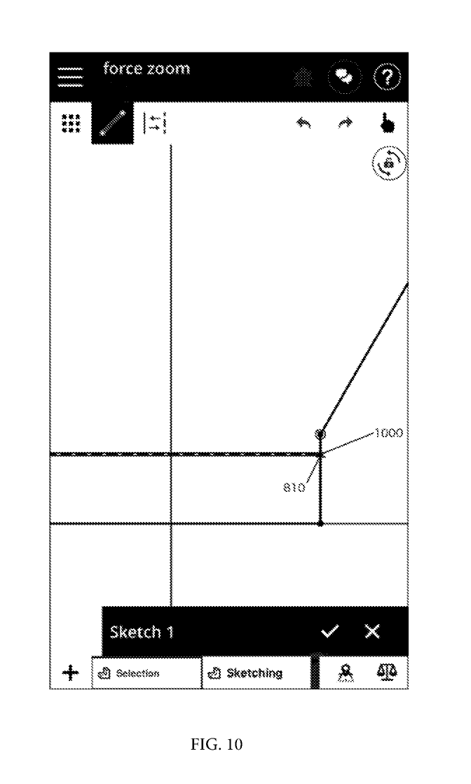

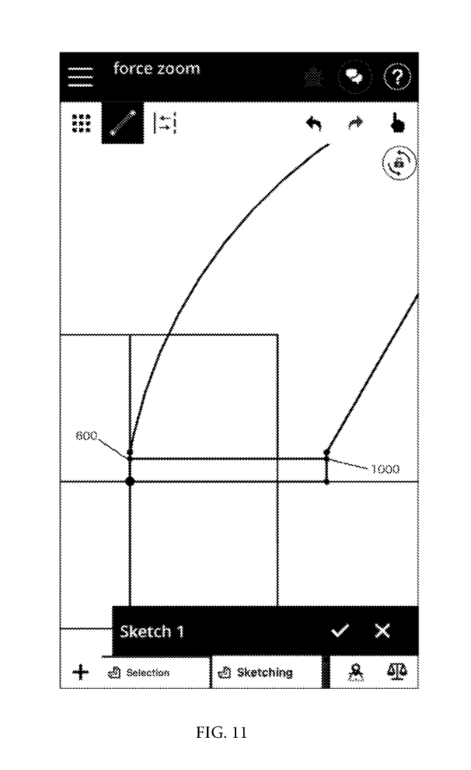

Referring to FIG. 4, a sketching program is operating on a mobile phone implementing force touch zoom selection. The user intent is to add a line connecting two vertical lines about ¾ of the way up. The touch event is represented by the cross-hairs 400, and at the default zoom level auto-snapping prevents that specific positioning selection. As shown in FIG. 4, selection automatically snaps or jumps to the mid-point 410 of one of the vertical lines. Also referring to FIG. 5, the selection point can also snap or jump to an endpoint 500 of the vertical line, making finer selection between the midpoint and endpoint impossible. As automatic snaps typically, as well as in this example application, are sized relative to the visual display (as they tools intended to aid users based on visual references), zooming in the display can avoid the problem and allow finer selection. Referring also to FIG. 6, by applying force during the touch, the application zooms in with the touch point 400 in a fixed location. With the increase in zoom, finer selection is possible without being automatically jumped or snapped to the endpoints or midpoint. Selection of a point 600 about ¾ of the way up the line is now possible. Referring also to FIG. 7, the first touch event ended, returning the display to normal zoom and retaining the zoomed selection point 600 as one selected endpoint of a line. Referring also to FIGS. 8 & 9, the second selection encounters the same conflict as encountered with the first selection, wherein auto-snapping to a midpoint 800 or endpoint 900 prevents specific selection through touchpoint 810 between the midpoint and endpoint. Referring also to FIG. 10, by applying force during the touch, the application zooms in with the touch point 810 in a fixed location. With the increase in zoom, finer selection is possible without being automatically jumped or snapped to the endpoints or midpoint. Selection of a point 1000 about ¾ of the way up the line is now possible. Referring also to FIG. 11, after selecting the desired endpoint of the line and releasing the touch control, the display zooms back to the original level, displaying the sketch now with a line inserted approximately ¾ of the way up the two vertical lines, connecting selected points 600 and 1000.

Other Embodiments

As discussed above, a stylus or other touching device may similarly be used in place of a finger to initiate and control a touch event. This may be done through pressure sensitive screens detecting pressure of the touch, or through the stylus or touching device performing the pressure measurement (as done with the Apple stylus for iPad devices). With a stylus or other device, additional measurements besides pressure may be made. For example, angle of stylus may be measured at initiation and during the touch event. This may be used to vary and enhance the zoom control, such as by altering the speed of zoom, or enabling pause, continuation, or ending zoom without ending the initiating touch event. Other measurements, such as rotation, may alternatively be used for such control. During a finger-controlled touch event, alternate gestures (such as through a second finger) may similarly be used to add equivalent enhanced zooming controls.

Another alternate embodiment may vary the rate of zoom proportional to pressure increase. For example, at initiation of the touch event, an initial pressure may be detected. Upon an increase in pressure during the touch event, zoom-in may begin with zoom rate proportional to the increase in pressure over the initial pressure. Thus, pressing harder allows a faster zoom, while reducing pressure (while still more than the initial touch) slows the zoom, allowing fine control of the zoom velocity.

It is to be understood that the above description is intended to be illustrative, and not restrictive. Many other embodiments will be apparent to those of skill in the art upon reviewing the above description. The scope of the disclosure should, therefore, be determined with reference to the appended claims, along with the full scope of equivalents to which such claims are entitled.

1. A method of zoom control within a computer application displayed on a touchscreen device, the method comprising:
operating a computer device displaying content on a touchscreen device;
detecting a touch event on the touchscreen device;
detecting an increase of pressure during the touch event;
zooming in displayed content in response to the detected increase in pressure; and
ending zoom of the displayed content after completion of the touch event.

2. The method of claim 1, further comprising:
identifying a selection within the displayed content at a current touch point during the touch event;
changing the selection based on any movement of the current touch point before or after zooming in; and
retaining the selection after completion of the touch event.

3. The method of claim 2, wherein zooming in is anchored around a selection point of the selection such that the selection point remains in a fixed position on a display of the touchscreen device while zooming.

4. The method of claim 3, further comprising maintaining display at a current zoom amount upon detecting a decrease of pressure during the touch event.

5. The method of claim 4, wherein zooming in zooms an amount proportional to a ratio of the detected pressure to a maximum pressure.

6. The method of claim 4, wherein zooming in zooms a fixed amount or a fixed percentage.

7. The method of claim 4, further comprising tracking a greatest pressure during the touch event, starting the greatest pressure as a pressure detected upon initiating the touch event, zooming in only if the detected increase of pressure reaches a greater pressure than the greatest pressure, and setting the greatest pressure to the detected pressure when zooming in.

8. The method of claim 4, further comprising detecting a change in the current touch point of the touch event after zooming in, changing the selection and selection point based on the change in the current touch point, and centering any further zoom around the changed selection point.

9. The method of claim 3, further comprising varying a rate of zoom proportional to the detected increase in pressure relative to an initial pressure of the touch event.

10. A non-transitory computer readable medium for zoom control within a computer application displayed on a touchscreen device, comprising instructions stored thereon that, when executed on a processor displaying content to a touchscreen device, perform the steps of:
detecting a touch event on the touchscreen device;
detecting an increase of pressure during the touch event;
zooming in displayed content in response to the detected increase in pressure; and
ending zoom of the displayed content after completion of the touch event.

11. The computer readable medium of claim 10, wherein the steps further comprise:
identifying a selection within the displayed content at a current touch point during the touch event;
changing the selection based on any movement of the current touch point before or after zooming in; and
retaining the selection after completion of the touch event.

12. The computer readable medium of claim 11, wherein zooming in is anchored around a selection point of the selection such that the selection point remains in a fixed position on a display of the touchscreen device while zooming.

13. The computer readable medium of claim 12, wherein the steps further comprise maintaining display at a current zoom amount upon detecting a decrease of pressure during the touch event.

14. The computer readable medium of claim 13, wherein zooming in zooms an amount proportional to a ratio of the detected pressure to a maximum pressure.

15. The computer readable medium of claim 13, wherein zooming in zooms a fixed amount or a fixed percentage.

16. The computer readable medium of claim 13,wherein the steps further comprise tracking a greatest pressure during the touch event, starting the greatest pressure as a pressure detected upon initiating the touch event, zooming in only if the detected increase of pressure reaches a greater pressure than the greatest pressure, and setting the greatest pressure to the detected pressure when zooming in.

17. The computer readable medium of claim 13, wherein the steps further comprise detecting a change in the current touch point of the touch event after zooming in, changing the selection and selection point based on the change in the current touch point, and centering any further zoom around the changed selection point.

18. The computer readable medium of claim 12, wherein the steps further comprise varying a rate of zoom proportional to the detected increase in pressure relative to an initial pressure of the touch event.
